(19) United States
(12) Patent Application Publication
(10) Pub. No.: US 2007/0255001 A1
(43) Pub. Date: Nov. 1, 2007

(54) Thermoplastic composite for construction materials and method of making

(76) Inventor: D. Todd Lemons, (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/413,758

(22) Filed: Apr. 27, 2006

(51) Int. Cl. C08K 3/40

(52) U.S. Cl. 524/494

(57) ABSTRACT

A thermoplastic composite core and shell and method of making.

### BACKGROUND

1. Field

This disclosure relates to materials and methods for producing construction materials.

2. Information

The construction industry is under constant pressure to provide quality products at low cost. To remain competitive manufacturers attempt to provide construction materials that are increasingly durable and lightweight. Construction materials made of natural wood have a number of disadvantages including, for instance cost, environmental impact, durability and reliability in comparison to other construction materials composed of thermoplastic materials. Therefore, the construction industry is increasingly using thermoplastic materials in the manufacture of construction materials. Many decorative and structural construction materials traditionally made of wood are now being made of thermoplastic materials.

Thermoplastic composites currently in use also have drawbacks, primarily cost, weight, decreased workability, environmental impact, and problems with deformation over time that can be brought about by thermal changes and/or regular use. This can be a problem especially with recycled thermoplastic composites. Additionally, problems related to their chemical makeup have been encountered. For instance, olefins such as Polypropylene (PP) and Polyethylene (PE) may exhibit a “waxy” surface that is difficult to paint with commercially available paints. Additionally the olefin-based plastics, especially those made from recycled materials, may exhibit coefficient of thermal expansion indexes outside acceptable parameters for some applications. Also, construction materials made from polyolefins exhibit poor nail and screw holding characteristics, particularly when subjected to temperatures above 80° F.

Polystyrene (PS) is easier to paint and somewhat more thermally stable than polyolefins, however, PS presents other functional deficiencies such as brittleness and poor machining properties. Like polyolefins, PS exhibits poor nail and screw holding characteristics, particularly when subjected to temperatures below 40° F. Certain construction members, such as, exterior door frames may need to withstand weather related extremes. Brittle materials may breakdown as a result of exposure to extreme temperatures and moisture.

Poly-vinyl-chloride (PVC) is easy to paint and has good machining properties but cannot be typically used in recycled form and as such is cost prohibitive. Additionally, some all-composite products, such as, for instance, PS and PVC tend to be as rigid as wood but more brittle than wood products. This causes problems with dimensional strength and machinability. Olefins such as, for instance, PP and PE may not be brittle but are typically not rigid enough for construction applications and tend to have poor coefficients of thermal expansion (CTE) indices. Poor flexibility and insufficient CTE indices typically also cause problems with dimensional stability, such as, warping and deformation.

In order to achieve commercially competitive physical properties, thermoplastic construction materials are typically altered using expensive additives and treatments such as impact modifiers to reduce brittleness and foaming to reduce resin weight and therefore cost as well as employing recycled plastics which reduce cost and environmental impact.

There are a variety of methods of shaping thermoplastic composites, such as, for instance, by extrusion and/or liquid molding. Shaping by extrusion of thermoplastics can be accomplished in a variety of ways, such as, for instance, by extruding a thermoplastic material through a device, such as a die, capable of shaping a thermoplastic composite. If desired, the shaped thermoplastic composite may later be coated with a variety of appropriate coatings. Co-extrusion is another method of extrusion that may entail extruding two or more materials together through a single die. For instance, a core material and a shell material may be extruded together through a die to form a construction member.

Additionally, shaping by liquid molding can be accomplished by a variety of methods. For instance, compression molding is a well known method of liquid molding. Compression molding may be accomplished by placing a thermoplastic composite into a heated molding die and then cooling the die. Another method of shaping by liquid molding may be by injection molding. Injection molding may involve feeding thermoplastic raw materials from a hopper through a heated feeding barrel during a melting stage. The liquid thermoplastic may then be injected through a nozzle into a molding die where it is cooled and removed. A third method of shaping a thermoplastic composite by liquid molding is co-injection molding. Co-injection molding is similar to simple injection molding. However, a second compound may be fed from a second hopper to a second feeding barrel. The two feeding barrels may meet at a sliding torpedo valve which may open or close the two nozzles at the end of the feeding barrels. The valve may open the first nozzle allowing one compound to enter the molding die and then the valve may shift to open the second nozzle allowing a second compound to enter the molding die.

There are a variety of other methods of shaping and molding thermoplastic composites not discussed in detail in this disclosure, such as, for example, resin transfer molding, structural reaction injection molding and vacuum assisted resin injection. However, claimed subject matter is not limited in this regard.

### BRIEF DESCRIPTION OF THE DRAWINGS

FIG. 1 Illustrates a flow chart of a particular embodiment of a process for producing a coated thermoplastic composite.

FIG. 2 depicts a perspective view of a particular embodiment of co-extrusion of core and shell material through a die.

FIG. 3 depicts a perspective view of a particular embodiment of a glass object.

FIG. 4 depicts a perspective view of a particular embodiment of a pre-form for a construction member.

FIG. 5a depicts a perspective view of a particular embodiment of a die.

FIG. 5b depicts a perspective view of a particular embodiment of a portion of a formed exterior door frame.

FIG. 6 Illustrates a flow chart of a particular embodiment of a process for producing a coated thermoplastic composite for a decorative outlay.

FIG. 7 depicts a perspective view of a particular embodiment of a portion of decorative outlay.

FIG. 8 depicts a perspective view of a particular embodiment of portion of crown molding.

FIG. 9 depicts a perspective view of a particular embodiment of a portion of an exterior door.

FIG. 10 depicts a perspective view of a particular embodiment of portion of decorative molding.

### DETAILED DESCRIPTION

In the following detailed description, various embodiments will be disclosed. For purposes of explanation, specific numbers, materials, and/or configurations are set forth in order to provide a thorough understanding of the embodiments. However, it will also be apparent to one skilled in the art that the embodiments may be practiced without one or more of the specific details or with other approaches, materials, components, etc. In other instances, well-known structures, materials, and/or operations are not shown in detail and may be described only briefly to avoid obscuring claimed subject matter. Accordingly, in some instances, features are omitted and/or simplified in order to not obscure the disclosed embodiments. Furthermore, it is understood that embodiments shown in the figures are illustrative representations and are not necessarily drawn to scale.

Co-extrusion and co-injection molding are two methods of shaping thermoplastic composites as illustrated in particular examples. However, such discussion of these particular methods is meant to be merely illustrative and is not meant to be limiting in any regard with respect to claimed subject matter. Also, co-extruding and co-injection molding are merely examples of methods of shaping a thermoplastic composite and claimed subject matter is not limited in this regard.

A number of shapes and varieties of materials are discussed herein, including, for example, construction materials. However, the various shapes such as, for instance, an exterior door frame or a decorative outlay are merely illustrative and do not limit claimed subject matter. Thermoplastic composite material is very versatile and many other shapes may be formed from a thermoplastic composite such as, for instance, tub railing, decorative inlays, window sills, window frames, computer packaging and automobile bumpers and claimed subject matter is not limited in this regard.

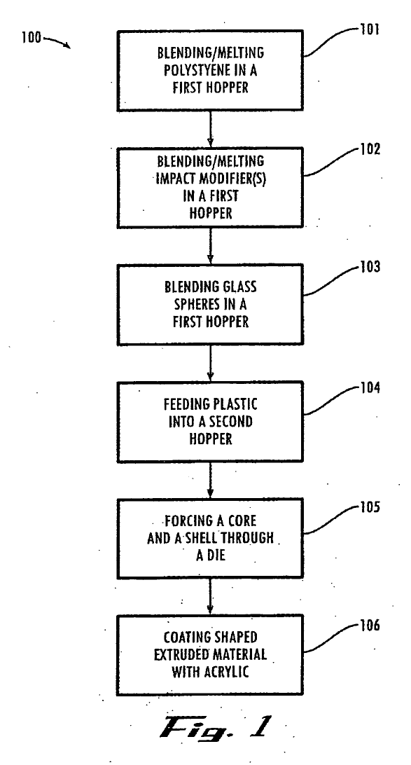

FIG. 1 illustrates a particular embodiment of a hot co-extrusion process 100 for producing a thermoplastic composite having a core and a shell for use in manufacturing a member such as a construction member. Such a construction member may comprise an exterior door frame, for example. Blocks 101-103 describe preparing a core for co-extruding a thermoplastic composite. Blocks 104-106 describe preparation of a shell for co-extrusion and a process for co-extruding a thermoplastic composite.

Block 101 comprises blending polystyrene (PS) pellets in a first funnel shaped hopper that may feed to a worm screw. Such a worm screw may drive the polystyrene pellets into tapered chamber. As the tapered chamber narrows pressure increases as does heat. In a particular embodiment, heat generated as the pressure increases may be sufficient to melt the pellets. In another embodiment, the tapered chamber may be lined with heating elements that may provide heat sufficient to melt polystyrene pellets. In a particular embodiment, polystyrene pellets may become a viscous mass. Additionally, the polystyrene pellets may comprise some percentage recycled polystyrene up to 100%. It is not required that the hot co-extrusion process be started in the way described above nor is it necessary that polystyrene take a pellet form or any particular form prior to blending and melting. This is merely an example of a method of blending and melting polystyrene during a hot co-extrusion process and claimed subject matter is not limited in this regard.

In a particular embodiment, polystyrene blended and melted at block 101 may comprise a thermally stabilizing pigment. In a particular embodiment, the thermally stabilizing pigment may be inherent to polystyrene, such as, for instance, with recycled black polystyrene. In another particular embodiment, a thermally stabilizing pigment may be added to the polystyrene being blended at block 101. In another particular embodiment, a thermally stabilizing pigment may be added elsewhere in process 100.

A thermally stabilizing pigment added to or inherent in polystyrene used to produce a thermoplastic composite may enable the thermoplastic composite to achieve certain properties related to thermal stability. In this context, such properties may comprise, for instance, an ability to withstand multiple cycles of temperature fluctuations such as with extreme weather conditions without substantial degradation. Other properties related to thermal stability may include an ability to conduct heat efficiently and/or the ability to exhibit CTE indices within certain parameters to enable particular applications of a thermoplastic composite.

Construction members such as exterior window or door frames are examples of particular applications of thermoplastic composites benefiting from CTE indices within certain defined parameters.

In a particular embodiment, a thermally stabilizing pigment, such as, iron oxide and/or carbon black may be added to a thermoplastic composite in order to impart thermally stabilizing properties to the thermoplastic composite. It should be recognized that a thermally stabilizing pigment may be inherent or added to and have an effect on a variety of materials, such as, for instance, any number of polymer blends. However, this is merely an example of varieties of materials and properties that may be affected by a thermally stabilizing pigment in a particular embodiment and claimed subject matter is not limited in this respect.

At block 102, the addition of a certain percentage by mass of impact modifiers to a thermoplastic composite during a hot co-extrusion process is illustrated. In a particular embodiment, impact modifier pellets may be fed into a first funnel shaped hopper and blended with polystyrene. As described above such a compound may feed to a worm screw that may drive the compound into a tapered chamber, thereby increasing heat and pressure to form polystyrene pellets and impact modifiers into a viscous mass. In a particular embodiment, impact modifiers may comprise between 0.25% and 2% by mass of a thermoplastic composite. However, this is merely an example of a method of blending and melting polystyrene pellets and impact modifier pellets during a hot co-extrusion process and claimed subject matter is not limited in this regard.

In a particular embodiment, a thermoplastic composite may be made with polystyrene and impact modifiers. Polystyrene tends to be brittle. Impact modifiers may be added to a thermoplastic composite to decrease brittleness and improve resistance, flexibility, machinability, durability and tangential strength. Also, impact modifiers may help enable a thermoplastic composite to withstand exposure to extreme temperatures and moisture.

According to an embodiment, impact modifiers may be made from a variety of substances, such as, for instance, various polyolefins and elastomers. In a particular embodiment, impact modifiers may comprise polypropylene (PP), polyethylene (PE) and/or thermo plastic rubber elastomer (TPRE). However, these are merely examples of a variety of impact modifiers and claimed subject matter is not limited in this respect. Additionally, impact modifiers may be made from some percentage of recycled materials up to 100%. For instance, in a particular embodiment, a particular impact modifier may be made from recycled rubber such as tires, weather stripping, seals and/or gaskets. However, this is merely an example of particular types of recycled materials that may comprise impact modifiers and claimed subject matter is not limited in this regard.

Commonly in the construction materials manufacturing industry, various methods of reducing the density or weight of expensive thermoplastic composite materials are used. Reduction in density or weight typically results in a materials cost savings. Some examples of methods employed to reduce the density or weight of thermoplastic composites are blowing or foaming with physical and or chemical methods, and/or the addition of certain fillers such as rice husk flour and/or calcium carbonate. Blowing or foaming may induce formation of air bubbles or a cellular structure into a substrate by adding chemical products such as Celogen®, Expandex®, and Opex® produced by Chemtura Corporation. These products may be used to reduce weight, improve softness and resilience, simulate the appearance and behavior of wood, and provide cosmetic surface effects. However, these are merely examples of products that may be added to induce formation of air bubbles and other products may be used. Another method of inducing a cellular structure into a thermoplastic composite is by using physical methods of forcing air into the thermoplastic composite. Foaming and blowing may create air bubbles and/or cellular structures that are not substantially uniform and may tend to deteriorate the structural and thermal integrity of the final product.

In a particular embodiment, substantially spherical glass objects (referred to hereinafter as “glass objects”) may replace other substances and/or methods of reducing density and/or weight of thermoplastic composites. The addition of glass objects may enable a thermoplastic composite to have a lowered density and/or weight while retaining thermal stability. In addition, glass objects may have isostatic properties that enable reducing density and/or weight of a thermoplastic composite without the risk of reducing structural integrity. However, this is merely an example of a substance that may be used to reduce density and/or weight of thermoplastic composites. There are many other substances suitable for this purpose, such as, for instance, rice husk flour or calcium carbonate and claimed subject matter is not limited in this regard. Additionally, in another embodiment no measures to reduce weight and/or density may be taken. For instance, construction materials having a small profile such as a bottom rail for a door may be manufactured without addition of weight and/or density reducing materials.

Block 103 illustrates an addition of a certain percentage by mass of glass objects to a mixture of polystyrene and at least one impact modifier. Glass objects may be fed into a first funnel shaped hopper and blended with polystyrene and at least one impact modifier. As described above the mixture may feed to a worm screw that may drive the mixture into a tapered chamber increasing heat and pressure, and incorporating the glass objects into the mixture. It should be understood, however, that it is not necessary that the glass objects be incorporated into the mixture after the polystyrene and impact modifiers have been added. Such glass objects may or may not be incorporated into the mixture but may be incorporated at any time without departing from claimed subject matter. This is merely an example of a method of blending and/or melting polystyrene pellets, impact modifier pellets and glass objects during a hot co-extrusion process and claimed subject matter is not limited in this regard.

According to an embodiment, glass objects may comprise 10% to 30% of the mass of a thermoplastic composite for use in a member such as an exterior door frame. However, this is merely an example of a percentage by mass of glass objects in a mixture for use in a construction member and claimed subject matter is not limited in this regard.

According to an embodiment, glass objects may have variety of diameters, densities and isostatic strength ranges. For instance, in a particular embodiment glass objects may have a diameter ranging from 30 to 120 microns, a density of 0.125 g/cc to 0.37 g/cc and an isostatic crush strength of 250 psi to 3000 psi. However, these are merely examples of dimensions glass objects may take in a particular embodiment and claimed subject matter is not limited in this regard.

Referring now to FIG. 3, illustrating a particular embodiment of a glass object 300. A glass object 300 may have a substantially central void 310 and may have substantially isotropic tensile strength properties. Glass objects having a substantially central void may have a wide range of wall thicknesses, such as, for instance, 0.1 to 50 microns. An example of such glass objects, according to a particular embodiment, may comprise Isostatic Thermo-Stabilizing Glass Microspheres manufactured by the 3M™ Company. However, these are just examples of-particular properties and varieties of glass objects that may be used in a particular embodiment and claimed subject matter is not limited in this regard.

The use of polystyrene in combination with an impact modifiers and glass objects may contribute to enabling a finished product, such as, an exterior door frame to have commercially advantageous physical properties. Such commercially advantageous physical properties may be enabled by the use of polystyrene in combination with impact modifiers and glass objects, to provide general dimensional stability, nail and screw hole indices meeting particular performance standards, paintability, balance of rigidity and flexibility, machineability, and cost competitiveness with wood products. However, these are merely examples of physical properties that may be enabled by the use of polystyrene in combination with impact modifiers and glass objects and claimed subject matter is not limited in this regard.

Referring again to FIG. 1, at block 104, shell materials may be fed into a second hopper. In a particular embodiment, a construction member, such as, for instance, an exterior door frame produced by a hot co-extrusion process may comprise a core and a shell. A core and a shell may be prepared separately during a hot co-extrusion process. According to a particular embodiment, two distinct raw material feed hoppers may be used. Core materials may be prepared in a first hopper, blended with a first worm screw and forced through a first tapered chamber that may be coextensive with the second tapered chamber ending at a co-extrusion die. As described above, a core may comprise at least polystyrene, impact modifiers and glass objects. According to a particular embodiment, shell material may be fed through a second hopper, blended with a second worm screw and forced through a second tapered chamber that may be coextensive with the first tapered chamber and end at the co-extrusion die. In a particular embodiment, a shell may comprise a variety materials, such as, for instance polymer pellets, impact modifiers and, optionally, glass objects. According to a particular embodiment, a shell may be processed in a similar way to that of the core material, as described in detail above. Such processing may include feeding raw materials into a second hopper, blending with a second worm screw and forcing shell materials through a second tapered chamber. In another particular embodiment, the shell material may comprise a variety of materials such as plastic, virgin and/or recycled white polystyrene (PS), butadiene styrene (BS), acrylic-styrene-acrylonitrile (ASA) and/or acrylonitrile-butadiene-styrene (ABS). Additionally, in a particular embodiment, a shell may comprise of a combination of at least one polymer, such as, for instance, PS, BS, ASA and/or ABS and impact modifiers. Using white PS, BS, ASA or ABS may enhance the desirability of the finished product as it is common for most fabricated construction materials to be produced in a color such as white. Additionally, ABS and ASA have high ultra violet (UV) resistance which may enable a reduction in deterioration of construction products such a door frames which will be exposed to UV rays. ASA may have the higher UV resistance of the two. However, these are merely examples of colors and varieties of polymers that may be used as a shell material in a particular embodiment and claimed subject matter is not so limited. For instance, there are many other materials such as polypropylene, polyethylene, polystyrene, butyl styrene, polyurethane and polyvinylchloride that may be suitable for this particular embodiment.

At block 105, a core and a shell may be forced through a co-extrusion die. To create the full door frame assembly, such a core may be co-extruded with an outer shell through a die which gives an end product its final shape. Such an end product in a particular embodiment may comprise an exterior door frame, for example. However, co-extrusion can be used to produce a wide variety of products and claimed subject matter is not limited in this respect. In a particular embodiment, a thermoplastic composite of at least polystyrene, impact modifiers and glass objects may comprise a core. According to a particular embodiment, a core may comprise an interior section of a finished product of extrusion or co-extrusion of a thermoplastic composite. Additionally, an exterior portion of a core may be substantially coated with a shell. Alternatively, in a particular embodiment, a core may comprise a finished product and have no shell coating. According to another particular embodiment, a shell may be decorative and/or may serve to protect a core from environmental conditions. In another particular embodiment, a shell may comprise a single layer of material or multiple layers of material. It should be understood, however, that these are merely examples of materials comprising, uses of and configurations for cores and shells and claimed subject matter is not limited to the particular embodiments described above.

According to a particular embodiment, a core and a shell may be co-extruded through a co-extrusion die attached to the end of the first and second tapered chambers. A co-extrusion die may be a device made for extruding two or more materials, such as, for instance, a core and a shell. In a particular embodiment, a co-extrusion die may have a single orifice 511, as depicted in FIG. 5a, through which the core and shell material may flow as the core and shell material exits the coextensive first and second tapered chambers. In a particular embodiment, core and shell materials may be highly viscous as they exit the first and second tapered chambers, therefore, when the two materials come into contact, the core and shell may bond together during co-extrusion without intermixing. According to a particular embodiment, core material may be coated with shell material before the core and shell are forced through a co-extrusion die to shape the co-extruded material as desired. It should be understood that there are many other ways a core and shell may be co-extruded, such as, in a particular embodiment, independently forcing the core and shell materials through different orifices in a die and then bonding the shell and the core materials together after extrusion. However, these are merely examples of methods of co-extruding a core and a shell material and claimed subject matter is not limited in this regard.

Block 106, illustrates a particular embodiment of a co-extrusion process for manufacturing an exterior door frame. After a door assembly has been co-extruded a high resin acrylic base primer may be applied to the exterior surface. In a particular embodiment, such a primer may act as a barrier between a core and shell and the environment. A primer may also enable use of water based paint for painting an end product of the co-extrusion process, such as an exterior door frame. Additionally, use of an acrylic based primer may reduce the use of costly UV inhibitor additives in the co-extruded shell and may enable close color matching tolerances. However, this is merely an example of a primer that may be applied to the surface of an exterior door frame and/or other end product of hot co-extrusion of a thermoplastic composite and claimed subject matter is not limited in this regard.

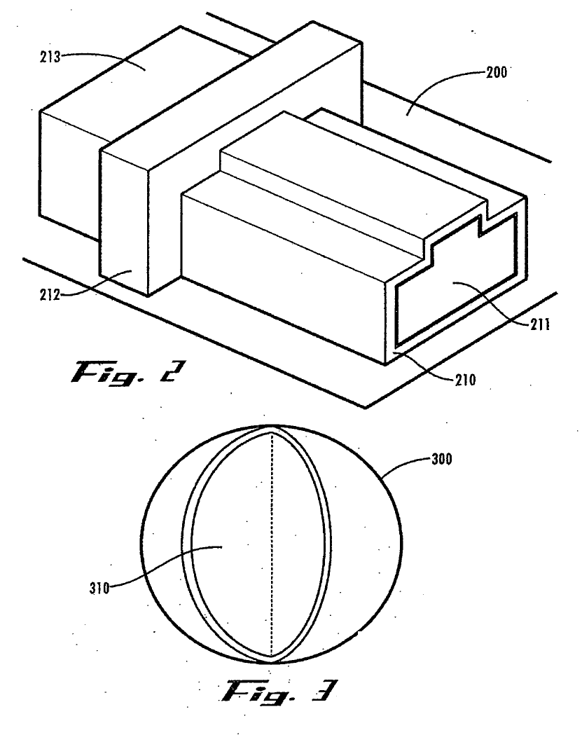

FIG. 2 illustrates a view of portion of an exterior door frame assembly 200 as it is shaped by die 212. In this particular embodiment, a core 211 and shell 210 are forced through a die 212 to form exterior door frame assembly 200. As discussed above with respect to FIG. 1, a core 211 and shell 210 may be co-extruded prior to passing through die 212 forming together a semisolid mass 213. Mass 213 is then forced through die 212 in order to be shaped as a finished product. As exterior door frame assembly 200 extends from die 212 it is cut to appropriate lengths. However, this is merely an example of a method of shaping an exterior door frame from a core and shell and claimed subject matter is not limited in this respect.

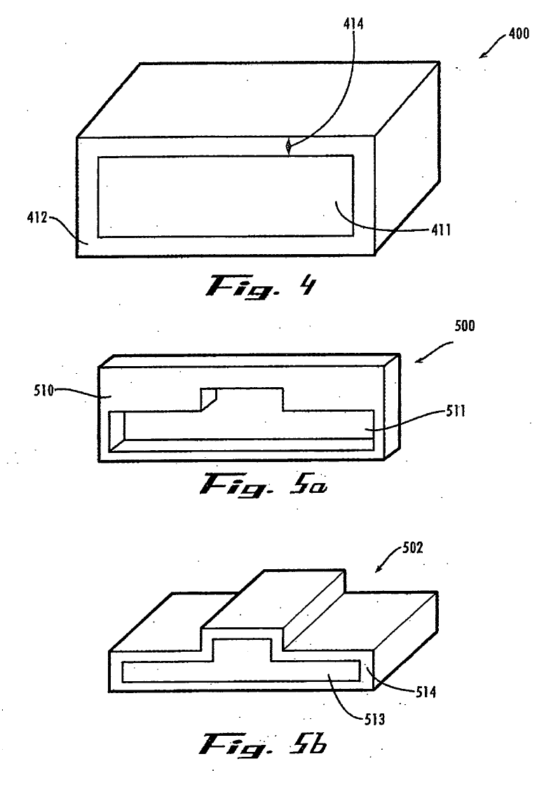

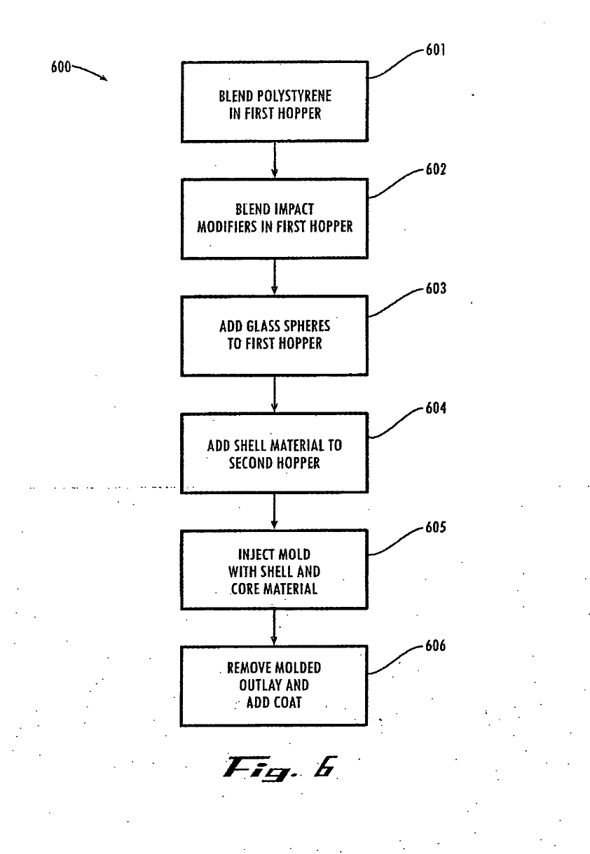

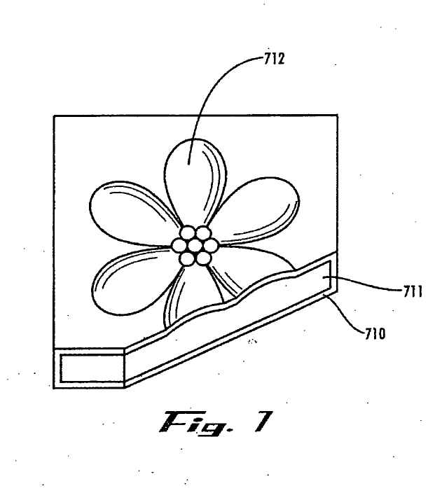

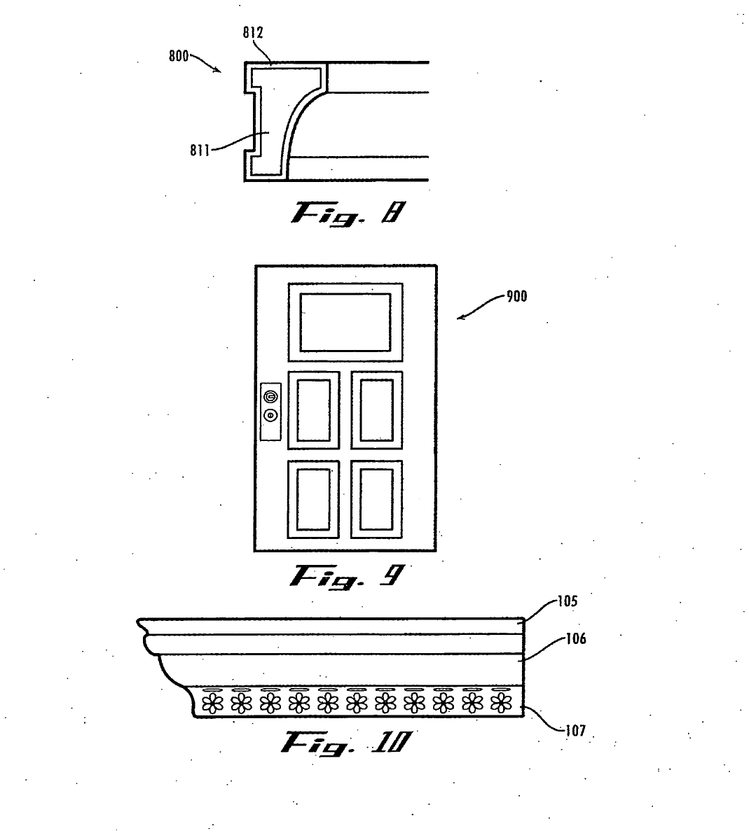

FIG. 4 shows a perspective view of a portion of a member, such as, an exterior door frame assembly 400 prior to shaping through a die. In a particular embodiment, a core 411 may comprise polystyrene, impact modifiers and glass objects. In a particular embodiment, a shell 412 may comprise an organic material such as BS, PS and/or ABS and may have a thickness 414 of at about 0.1-0.5 mm. However, these are merely examples of materials and thicknesses of a shell in a particular embodiment of a member and claimed subject matter is not limited in this respect.

FIG. 5a depicts a perspective view of a die 500 used to shape a member, such as, an exterior door frame assembly (not shown) during a hot-co-extrusion process. As can be seen in FIG. 5a, die 500 has a central void 511 and a solid portion 510. Core and shell material (not shown) may be forced through central void 511 which imparts a shape to a shell and core. In a particular embodiment, a die may comprise die grade steel (D-2, W-4, Stainless Steel, etc.) and may be coated with a hard chromium coating. However, this is merely an example of a shape of a die and materials that may comprise a die in a particular embodiment and claimed subject matter is not limited in this respect.

FIG. 5b depicts a view of a member, such as, an exterior door frame 502. Core 513 and shell 514 exhibit the shape given by being forced through a die (as seen in FIG. 5a).

FIG. 6 illustrates a particular embodiment of a co-injection molding process 600 for producing a coated thermoplastic composite for use in manufacturing any number of a variety of construction members, such as, for instance, a decorative outlay. Blocks 601-603 describe a process for preparing a core for co-injection molding of a thermoplastic composite. Blocks 604-605 describe preparation of a shell for co-injection molding of a thermoplastic composite.

Process 600 may start at block 601 by blending polystyrene pellets into a first funnel shaped hopper that may feed to a barrel containing a reciprocating screw or a ram injector. The barrel may have heating elements for melting raw material as the reciprocating screw or ram injector drives the polystyrene pellets down the shaft of the barrel toward a nozzle. Heat from the heating elements may melt polystyrene pellets into a viscous mass. The polystyrene pellets may comprise some percentage recycled polystyrene up to 100%. It is not necessary that polystyrene take a pellet form or any particular form prior to blending and melting, for instance, polystyrene may be supplied in other shapes and/or in states other than solid. This is merely an example of a method of blending and melting polystyrene during a co-injection molding process and claimed subject matter is not limited in this regard.

In a particular embodiment, polystyrene blended and melted at block 601 may contain a thermally stabilizing pigmentation. In a particular embodiment, a thermally stabilizing pigment may be black in color. In a particular embodiment, iron oxide and/or carbon black may impart a black color to a polystyrene blend. However, these are merely examples of thermally stabilizing pigments that may be black in color and claimed subject matter is not limited in this respect. As discussed above, a thermally stabilizing pigment may impart a thermoplastic composite with certain properties related to thermal stability. Such properties may include an ability to transfer heat efficiently and to withstand weather related temperature extremes without substantial material degradation. Further, as discussed above, a thermally stabilizing pigment may impart properties to polystyrene blended at block 601 such that a finished product may meet particular performance standards for construction material, such as, having particular CTE indices. However, this is merely an example of thermally stabilizing pigment and properties affected by thermally stabilizing pigmentation of a particular embodiment of a thermoplastic composite and claimed subject matter is not limited in this respect.

Block 602 comprises the addition of a certain percentage by mass of impact modifiers during a co-injection molding process. In a particular embodiment, impact modifiers may comprise 0.25% by mass of a thermoplastic composite. However, this is merely an example of a percentage by mass of impact modifiers in a thermoplastic composite and claimed subject matter is not limited in this regard. As discussed above, impact modifiers may be incorporated into a thermoplastic composite for improving certain properties of finished products, such as, for instance, impact resistance. In a particular embodiment, impact modifier pellets may also be fed into a first funnel shaped hopper and blended with polystyrene. As described above, the mixture may feed to a heated barrel containing a reciprocating screw or a ram injector that may drive the mixture down the shaft of the heated barrel toward a nozzle. The heat may melt polystyrene pellets and impact modifiers into a viscous mass. However, this is merely an example of a method of blending and melting polystyrene pellets and impact modifier pellets during a co-injection molding process and claimed subject matter is not limited in this regard.

As described above, impact modifiers may be made from some percentage of recycled materials up to 100%. Impact modifiers may comprise polypropylene (PP), polyethylene (PE) and/or thermo plastic rubber elastomer (TPRE). Again, however, these are merely examples of various types of impact modifiers that may be used in particular embodiments, and claimed subject matter is not so limited.

Again, as discussed above, substantially uniform glass objects (referred to hereinafter as “glass objects”) may replace other substances for reducing density and/or weight of thermoplastic composites.

Block 603 of FIG. 6 illustrates an addition of a certain percentage by mass of glass objects to a mixture of polystyrene and impact modifiers according to an embodiment. In a particular embodiment, glass objects may comprise 10% by mass of a thermoplastic composite. However, this is merely an example of a percentage by mass of glass objects in a thermoplastic composite and claimed subject matter is not limited in this regard. Glass objects may be fed into a first funnel shaped hopper and blended with polystyrene and impact modifiers. As described above, the mixture may be fed to a heated barrel while a reciprocating screw or a ram injector may drive the mixture down the shaft of the barrel and incorporate the glass objects into the mixture. It is not necessary that the glass objects be incorporated into the mixture after the polystyrene and impact modifiers have been added. They may be incorporated at different times either before or after the polystyrene and/or impact modifiers have been added. It should be understood, however, that this is merely an example of a method of blending and melting polystyrene pellets, impact modifier pellets and glass objects during a co-injection molding process and that claimed subject matter is not limited in this regard.

As in the forgoing example of an exterior door frame, glass objects may comprise 10% to 30% of the mass of the thermoplastic composite. However, this is merely an example of a percentage by mass of glass objects in a particular embodiment and claimed subject matter is not limited in this regard. Glass objects may be of a variety of diameters, may have a substantially central void and may have substantially isotropic tensile strength properties. However, these are merely examples of particular properties and varieties of glass objects that may be used in a particular embodiment of a thermoplastic composite and claimed subject matter is not limited in this regard.

Block 604 comprises preparation of a shell according to a particular embodiment. Here, during a co-injection molding process two distinct raw material feed hoppers, barrels and reciprocating screws or ram injectors may be used. In a particular-embodiment, core materials may be fed through a first hopper and shell material may be fed through a second hopper. According to a particular embodiment, a shell may be composed of a single polymer or a combination of at least one polymer such as PS, BS, ASA and/or ABS, at least one impact modifier and optionally, glass objects. Shell materials including a polymer, at least one impact modifier and glass objects may be processed in a second hopper and barrel with a second reciprocating screw or ram injector. In another embodiment, shell material may comprise virgin and/or recycled white BS, PS, ASA and/or ABS. As described above, using white BS, PS, ASA and/or ABS may enhance the desirability of the finished product as it is common for fabricated construction materials to be produced in such a color. Additionally, ABS and ASA have high ultra violet (UV) resistance which may be necessary for construction members which will be exposed to UV rays. It should be understood that there are many other substances suitable for use in a particular embodiment of a shell, such as, for instance, PVC, PP and PE. However, these are merely examples of colors and varieties of materials that may be used in a particular embodiment of a shell and claimed subject matter is not so limited.

At block 605, shell and core materials may be injected into a decorative outlay mold. To create a decorative outlay, shell and core material may be injected into a mold simultaneously or in succession depending on the shape of the mold. In this particular embodiment, a shell may be injected into a mold first and followed by an injection of a core into the mold in rapid succession. The core and shell materials are injected into the decorative mold through separate nozzles at the end of each barrel by respective reciprocating screws or ram injectors. The mold receives the shell and then the core material and is cooled to a temperature, allowing shell and core material to solidify. Finally, the shell and core materials are removed from the mold. However, this is merely an example of a method of molding a thermoplastic composite and claimed subject matter is not limited in this regard.

At block 606, a decorative outlay may be removed and coated, according to a particular embodiment of a co-injection molding process for manufacturing a decorative outlay. After such a decorative outlay is removed from a mold a primer may be applied to the exterior surface. Such a primer may comprise any one of variety of substances may be used, such as, for instance, oil based primer, acrylic primer and/or latex primer. However, this is merely an example of a variety of primers that may be applied to the surface of a decorative outlay and claimed subject matter is not limited in this respect.

Referring now to FIG. 7, a particular embodiment of a decorative outlay produced by a co-injection molding of a thermoplastic composite is depicted. Core 711 and shell 710 are formed together via co-injection molding to produce a decorative outlay as discussed above with reference to FIG. 6. As can be seen in FIG. 7, a flower shaped outlay 712 may be formed in a mold (not shown). However, this is merely an example of a finished product of co-injection molding of a thermoplastic composite material and claimed subject matter is not limited in this respect.

FIGS. 8, 9 and 10 depict various embodiments of products produced by extrusion and/or liquid molding of a thermoplastic composite. It should be understood, however, that these are merely examples of products capable of being produced by extrusion and/or liquid molding of a thermoplastic composite and claimed subject matter is not limited in this regard.

FIG. 8 depicts a side profile of crown molding 800 produced by co-extrusion of a core 811 and shell 812. Core 811 may comprise at least a polystyrene, impact modifier and glass objects. Shell 812 may comprise a plastic such as PS or ABS. However, this is merely an example of a finished product of co-extrusion of a thermoplastic composite material and claimed subject matter is not limited in this respect.

FIG. 9 depicts a front view of an exterior door 900 produced by co-injection molding of a thermoplastic composite. However, this is merely an example of a finished product of co-injection molding of a thermoplastic composite material and claimed subject matter is not limited in this respect.

FIG. 10 depicts a front view of crown molding 105 produced by co-extrusion of a top portion 106. Top portion 106 may be coupled to bottom portion 107, bottom portion 107 may comprise a thermoplastic composite shaped by injection molding and coupled to top portion 106 by coating a core (not shown) with a plastic such BS PS or ABS (not shown) composed of a plastic such as BS. However, this is merely an example of a finished product of co-extrusion of a thermoplastic composite material and claimed subject matter is not limited in this respect.

While certain examples of claimed subject matter have been illustrated herein, many modifications, substitutions, changes and equivalents may occur without deviating from claimed subject matter. It is, therefore, to be understood that the appended claims are intended to cover such embodiments, modifications, substitutions and equivalents.

What is claimed is:

1. A method comprising:
combining at least one polymer, at least one impact modifier and substantially spherical glass objects to provide a composite.

2. The method of claim 1 further comprising:
forming a core comprising said combination of at least one polymer, at least one impact modifier and substantially spherical glass objects; and
coating said core with a shell comprising at least one organic material.

3. The method of claim 1, wherein said at least one polymer further comprises polystyrene.

4. The method of claim 3, wherein said polystyrene further comprises recycled material.

5. The method of claim 1, wherein said at least one impact modifier is selected from the group consisting of acrylic, polyolefin and elastomer.

6. The method of claim 4, wherein said polyolefin comprises recycled polyolefin.

7. The method of claim 2, wherein the at least one organic material is selected from the group consisting of butadiene styrene, butyl styrene, polyvinylchloride, butadiene styrene, acetyl butyl styrene, acrylonitrile styrene acrylate, polyurethane, acrylonitrile-butadiene-styrene and polystyrene.

8. The method of claim 3, wherein said composite further comprises at least one thermally stabilizing pigment.

9. The method of claim 8, wherein said at least one thermally stabilizing pigment is substantially black in color.

10. The method of claim 8, wherein said at least one thermally stabilizing pigment comprises iron oxide and/or carbon black.

11. The method of claim 1, and further comprising shaping said combination of at least one polymer, at least one impact modifier and substantially spherical glass objects by a process including extrusion.

12. The method of claim 2, wherein said forming said core further comprises shaping said core and shell by a process including co-extrusion.

13. The method of claim 1, and further comprising forming said composite of at least one polymer, at least one impact modifier and substantially spherical glass objects in a mold.

14. The method of claim 2, wherein said forming said core further comprises forming said core in a mold by a process including co-injection molding.

15. The method of claim 2, wherein said shell has a thickness of about 0.1 mm to 0.5 mm.

16. The method of claim 1, wherein the at least one impact modifier is selected from the group consisting of polypropylene, polyethylene and thermoplastic rubber elastomer.

17. The method of claim 2, wherein the at least one organic material is selected from the group consisting of butyl styrene, polyvinylchloride, butadiene styrene, acetyl butyl styrene, acrylonitrile styrene acrylate, polyurethane, acrylonitrile-butadiene-styrene and polystyrene.

18. The method of claim 2, wherein said shell further comprises at least one polymer and at least one impact modifier.

19. The method of claim 18, wherein said shell further comprises substantially spherical glass objects.

20. The method of claim 1, wherein the substantially spherical glass objects comprise 10% to 30% by mass of the composite.

21. The method of claim 1 and further comprising fabricating at least one construction member from said composite.

22. A method comprising;
combining at least one polymer, at least one impact modifier and a thermally stabilizing pigment.

23. The method of claim 22, wherein said polymer comprises polystyrene.

24. The method of claim 23, wherein said polystyrene further comprises recycled material.

25. The method of claim 22, wherein said at least one thermally stabilizing pigment is black in color.

26. The method of claim 22, wherein said at least one thermally stabilizing pigment further comprises iron oxide and/or carbon black.

27. A apparatus comprising:
a core composite comprising at least one polymer, at least one impact modifier and substantially spherical glass objects and a shell disposed over said core composite.

28. The apparatus of claim 27, wherein said shell further comprises at least one organic material.

29. The apparatus of claim 27, wherein said polymer further comprises polystyrene.

30. The apparatus of claim 27, wherein said polystyrene further comprises recycled material.

31. The apparatus of claim 27, wherein said at least one impact modifier selected from the group consisting of acrylic, polyolefin and or elastomer.

32. The apparatus of claim 27, wherein said impact modifier comprises recycled material.

33. The apparatus of claim 29, wherein said polystyrene further comprises at least one thermally stabilizing pigment.

34. The apparatus of claim 33, wherein said at least one thermally stabilizing pigment is black.

35. The apparatus of claim 33, wherein said at least one thermally stabilizing pigment further comprises iron oxide and/or carbon black.

36. The apparatus of claim 27, wherein the core and shell are co-extruded.

37. The apparatus of claim 27, wherein the core and shell are formed in a mold.

38. The apparatus of claim 27, wherein the core and shell are formed in a mold by a process including co-injection molding.

39. The apparatus of claim 27, wherein the shell has a thickness of about 0.1 mm to 0.5 mm.

40. The apparatus of claim 27, wherein the at least one impact modifier is selected from the group consisting of polypropylene, polyethylene and thermo plastic rubber elastomer.

41. The apparatus of claim 28, wherein the at least one organic material is selected from the group consisting of butadiene styrene, butyl styrene, polyvinylchloride, butadiene styrene, acetyl butyl styrene, acrylonitrile styrene acrylate, polyurethane, acrylonitrile-butadiene-styrene and polystyrene.

42. The apparatus of claim 27, wherein the substantially spherical glass objects comprise about 10% to 30% by mass of the core.

43. The apparatus of claim 27, wherein said shell further comprises at least one polymer and at least one impact modifier.

44. The apparatus of claim 27, wherein the core and shell further comprise a door frame.

45. The apparatus of claim 27, wherein the core and shell further comprise a window frame.

46. The apparatus of claim 27, wherein the core and shell further comprise a decorative outlay.

47. The apparatus of claim 27, wherein the core and shell further comprise crown molding.

48. The apparatus of claim 27, wherein the core and shell further comprise a tub rail.

49. The apparatus of claim 27, wherein the core and shell further comprise a door.

50. A construction apparatus comprising:
at least one polymer, one impact modifier and at least one thermally stabilizing pigment.

51. The construction apparatus of claim 50 wherein said polymer comprises polystyrene.

52. The construction apparatus of claim 51 wherein said polystyrene further comprises recycled material.

53. The construction apparatus of claim 50 wherein said thermally stabilizing pigment is black in color.

54. The construction apparatus of claim 50 wherein said thermally stabilizing pigment further comprises iron oxide and/or carbon black.

55. The construction apparatus of claim 50 further comprising bottom rails.
